(19) United States
(12) Patent Application Publication
(10) Pub. No.: US 2014/0103161 A1
(43) Pub. Date: Apr. 17, 2014

(54) Three-Dimensional Airport

(71) Applicants: Guobiao Zhang, Corvallis, OR (US); ChengDu HaiCun IP Technology LLC, ChengDu (CN)

(72) Inventor: Guobiao ZHANG, Corvallis, OR (US)

(21) Appl. No.: 13/931,955

(22) Filed: Jun. 30, 2013

Related U.S. Application Data
(60) Provisional application No. 61/718,701, filed on Oct. 25, 2012.
(60) Provisional application No. 61/713,499, filed on Oct. 13, 2012.
(60) Provisional application No. 61/713,475, filed on Oct. 12, 2012.

(51) Int. Cl. B64F 1/22; B64F 1/10; B64F 1/305

(52) U.S. Cl. CPC B64F 1/22; B64F 1/305; B64F 1/10
USPC 244/114 R

(57) ABSTRACT

The present invention discloses a three-dimensional (3-D) airport. In a 3-D airport, the airplanes are parked in an interleaved manner on at least two levels of parking surfaces. Portions of the wings of adjacently parked airplanes overlap.

### CROSS-REFERENCE TO RELATED APPLICATIONS

This application claims priority of a provisional application entitled “Three-Dimensional Airport”, Application Ser. No. 61/718,701, filed Oct. 25, 2012; this application also claims priority of another provisional application entitled “Three-Dimensional Airport”, Application Ser. No. 61/713,499, filed Oct. 13, 2012; this application further claims priority of a provisional application entitled “Three-Dimensional Airport”, Application Ser. No. 61/713,475, filed Oct. 12, 2012.

### BACKGROUND

1. Technical Field of the Invention

The present invention relates to the field of airport, and more particularly to airplane parking structures.

2. Prior Arts

An airport comprises at least a terminal building, which can accommodate a plurality of airplanes. FIG. 1A is a top view of a conventional terminal building 10 accommodating three airplanes 30A-30C in prior art. The terminal building comprises a security gate 12 and three boarding gates 16A-16C. Three airplanes 30A-30C are parked in their respective designated parking spaces A1-C1 and docked to their respective boarding bridges 14A-14C. These boarding bridges 14A-14C are coupled to the terminal building 10 at the boarding gates 16A-16C, respectively. For the terminal building 10, its length L is roughly equal to the product of its one-side docking capacity (i.e. the number of airplanes that can be docked on one side of the terminal building) and the width of the parking space W. FIG. 1B is a front view of three parked airplanes 30A-30C in prior art. The conventional airport is a two-dimensional airport, i.e. all airplanes 30A-30C are parked at the same level of parking surface, e.g. on the ground 16. To ensure safety, the width of the parking space W should be wider than the wingspan of the airplane. Because of the large wingspan of the airplanes, the width of the parking space W is generally large. Accordingly, a passenger needs to walk a long distance from the security gate 12 to the airplane (e.g. 30C). Furthermore, because the docking capacity of the terminal building 10 is limited, a large number of terminal buildings have to be constructed for a large airport.

### OBJECTS AND ADVANTAGES

It is a principle object of the present invention to shorten the walking distance of a passenger to board an airplane in a terminal building at an airport.

It is a further object of the present invention to increase the docking capacity of a terminal building at an airport.

It is a further object of the present invention to minimize the number of terminal buildings in an airport.

It is a further object of the present invention to minimize the construction cost of an airport.

It is a further object of the present invention to increase the capacity of an airplane hangar.

It is a further object of the present invention to increase the capacity of an aircraft carrier.

In accordance with these and other objects of the present invention, the present invention discloses a three-dimensional (3-D) airport.

### SUMMARY OF THE INVENTION

The present invention discloses a three-dimensional (3-D) airport. In a 3-D airport, airplanes are parked in an interleaved manner on at least two levels of parking surfaces: a first parking surface and a second parking surface. The first parking surface is typically the ground, while the second parking surface is on top of an elevated parking structure. Airplanes can be parked closer by overlapping portions of the wings thereof. In one preferred embodiment, the elevated parking structure is fixed. Preferably, a sloping surface connects the first and second parking surfaces. In another preferred embodiment, the elevated parking structure is movable. When it is not used for parking, the movable elevated parking structure is cleared off the parking space in such a way that this parking space has a flat surface with surrounding areas and can be used for taxiing or other purposes. The concept of the 3-D airport can also be applied to airplane hangars and/or aircraft carriers.

### BRIEF DESCRIPTION OF THE DRAWINGS

FIG. 1A is a top view of a terminal building accommodating three airplanes at a conventional airport in prior art; FIG. 1B is a front view of three parked airplanes at the conventional airport in prior art;

FIG. 2A is a top view of a preferred terminal building accommodating three airplanes in a preferred 3-D airport; FIG. 2B is its front view;

FIG. 3 is a top view of another preferred terminal building accommodating five airplanes in another preferred 3-D airport;

FIGS. 4A-4C are side views of a preferred elevated parking structure in the first type of the 3-D airport; FIGS. 4A-4C also illustrate three means for moving an airplane onto/off the preferred elevated parking structure;

FIG. 5A is a front view of three parked airplanes in the second type of the 3-D airport; and FIG. 5B is its side view;

FIGS. 6A-6C illustrate three parking steps used by a first preferred airplane parking method in the second type of the 3-D airport. These figures are front views of the parked airplanes;

FIGS. 7A-7C illustrate three parking steps used by a second preferred airplane parking method in the second type of the 3-D airport. These figures are side views of the parked airplanes;

FIGS. 8A and 8B are top views of the airplanes corresponding to the parking steps of FIGS. 7A and 7C, respectively;

FIGS. 9A-9C illustrate three parking steps used by a third preferred airplane parking method in the second type of the 3-D airport. These figures are side views of the parked airplanes;

FIGS. 10A-10C illustrate three parking steps used by a fourth preferred airplane parking method in the second type of the 3-D airport. These figures are side views of the parked airplanes;

FIGS. 11A-11C illustrate three parking steps used by a fifth preferred airplane parking method in the second type of the 3-D airport. These figures are side views of the parked airplanes.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

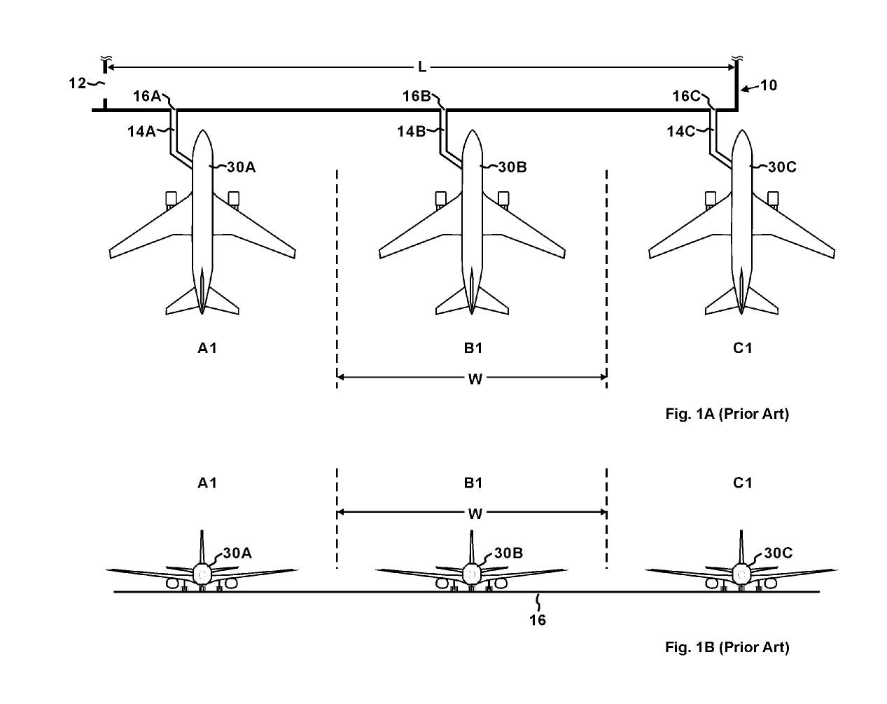

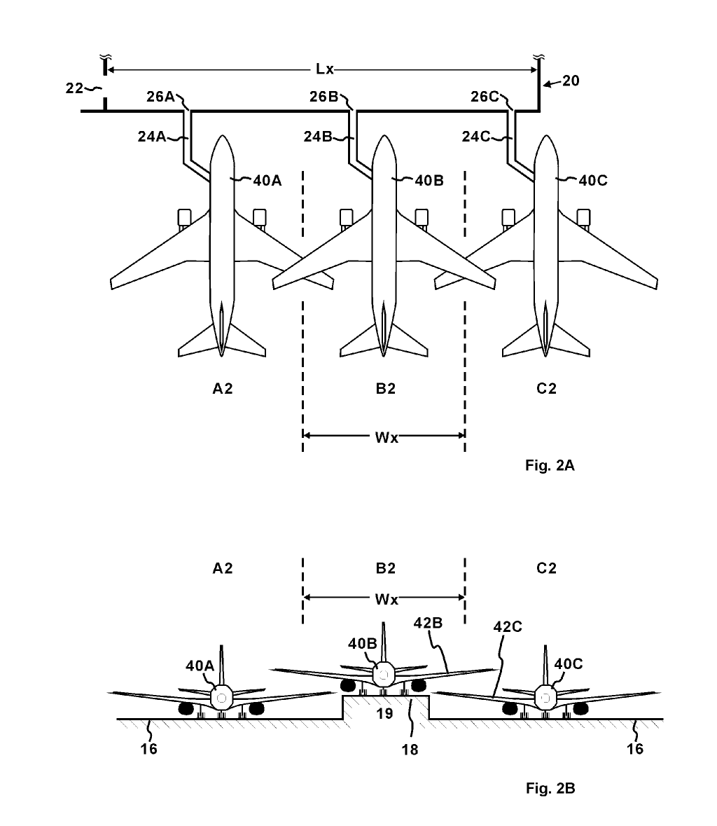

Referring now to FIGS. 2A-2B, a preferred terminal building 20 of a preferred 3-D airport is shown. It comprises a security gate 22 and three boarding gates 26A-26C. Three airplanes 40A-40C are parked in their respective designated parking spaces A2-C2 and docked to their respective boarding bridges 24A-24C. These boarding bridges 24A-24C are coupled to the terminal building 20 at the boarding gates 26A-26C, respectively (FIG. 2A). In this preferred embodiment, the airplanes 40A-40C are not parked at the same level of parking surface, but on at least two levels of parking surfaces: a first parking surface 16 and a second parking surface 18 (FIG. 2B). The first parking surface 16 is typically the ground, while the second parking surface 18 is on top of an elevated parking structure 19. The airplane (e.g. 40A, 40C) parked on the first parking surface 16 is referred to as the first-level airplane, while the airplane (e.g. 40B) parked on the second parking surface 18 is referred to as the second-level airplane. These airplanes 40A-40C are parked in an interleaved manner in such a way that at least a portion of a wing 42B of the airplane 40B overlaps at least another portion of a wing 42C of the airplane 40C. This overlap can shorten the width Wx of the parking space B2 to less than the wingspan of the airplane 40B. For the same docking capacity (three for both FIGS. 1A-1B and FIGS. 2A-2B), the length Lx of the terminal building 20 at a 3-D airport can be much shorter than the length L of the conventional terminal building 10 from prior art. As a result, a passenger walks a shorter distance to board an airplane (e.g. 40C).

In FIG. 2A, all boarding gates 24A-24C are located on the same boarding floor with respect to the ground. Alternatively, the terminal building 20 comprises at least two boarding floors: a first boarding floor and a second boarding floor, with the second boarding floor located above the first boarding floor. The boarding gates (e.g. 26B) for the second-level airplanes (e.g. 40B) are located on the second boarding floor, while the boarding gates (e.g. 26A, 26C) for the first-level airplanes (e.g. 40A, 40C) are located on the first boarding floor. As a result, the boarding bridges for the all airplanes (e.g. 40A-40C) are substantially level, which facilitates emplaning and deplaning.

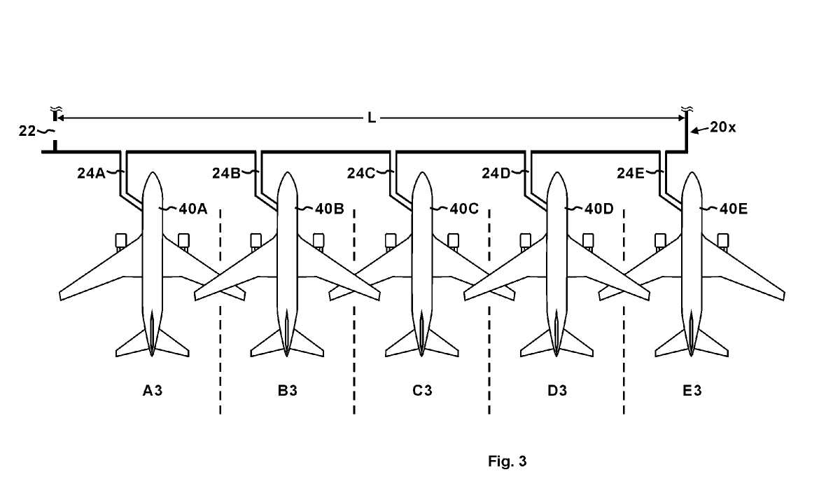

Referring now to FIG. 3, another preferred terminal building 20x is shown. It has the same length L as that of FIG. 1A. This terminal building 20x can accommodate five airplanes 40A-40E. They are parked in their respective designated parking spaces A3-E3 and docked to their respective boarding bridges 24A-24E. By arranging the airplanes in an interleaved manner as those in FIGS. 2A-2B, this preferred terminal building 20x has a docking capacity almost twice (five vs. three) as much as the conventional terminal building 10 in prior art. For a given airport capacity, the 3-D airport uses fewer terminal buildings than prior art and has a lower construction cost. In addition, it is relatively easy to convert a conventional airport into a 3-D airport. The only additions are elevated parking structures and extra boarding bridges. This leads to a minimal conversion cost.

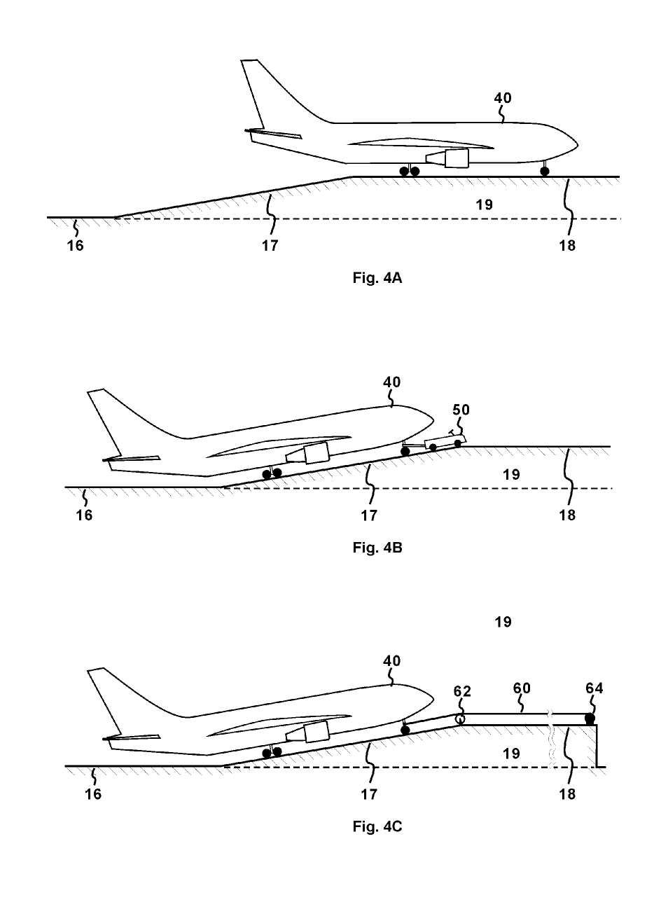

Referring now to FIGS. 4A-4C, side views of a preferred elevated parking structure in the first type of the 3-D airport are disclosed. In the first type of the 3-D airport, the elevated parking structure 19 is fixed, preferably on the ground 16. The elevated parking structure 19 further comprises a sloping surface 17 connecting the first parking surface 16 and the second parking surface 18. The inclination of this sloping surface 17 with respect to the ground 16 is preferably less than 45 degree. A less inclined sloping surface 17 will make it easier to move an airplane 40 onto/off the elevated parking structure 19.

FIGS. 4A-4C also illustrate three means for moving an airplane 40 onto/off the elevated parking structure 19. In FIG. 4A, the airplane 40 is self-propelled onto the elevated parking structure 19. In FIGS. 4B-4C, the airplane 40 is moved by an external means. The external means of FIG. 4B is a tug or a tractor 50. The tug or tractor 50 can also push the airplane 40 off the elevated parking structure 19. The external means of FIG. 4C is a cable system, which comprises at least a cable 60, a pulley 62 and a motor 64. When lowering the airplane 40 onto the ground 16, the cable system is particularly advantageous because it can do so in a controlled manner. In the preferred embodiment of FIG. 4C, the cable 60 is located out in the open. Alternatively, the cable 60 can be located inside a channel underneath the parking surfaces. This under-the-surface cable system can be realized in a way similar to the cable car of San Francisco and its implementation should be apparent to those skilled in the art.

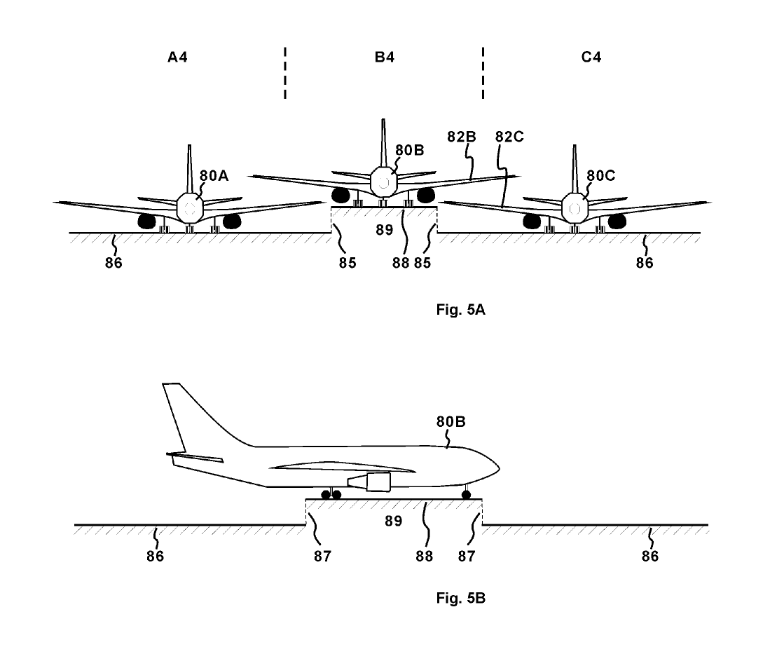

Referring now to FIG. 5A-5B, a preferred elevated parking structure in the second type of the 3-D airport is disclosed. In the second type of the 3-D airport, the elevated parking structure is movable. Similar to FIGS. 2A-2B, three airplanes 80A-80C are parked in their respective designated parking spaces A4-C4 and on at least two levels of parking surfaces: a first parking surface 86 and a second parking surface 88. The first parking surface 86 is typically the ground, while the second parking surface 88 is on top of an elevated parking structure 89. The airplanes 80A-80C are parked in an interleaved manner in such a way that at least a portion of a wing 82B of the airplane 80B overlaps at least another portion of a wing 82C of the airplane 80C.

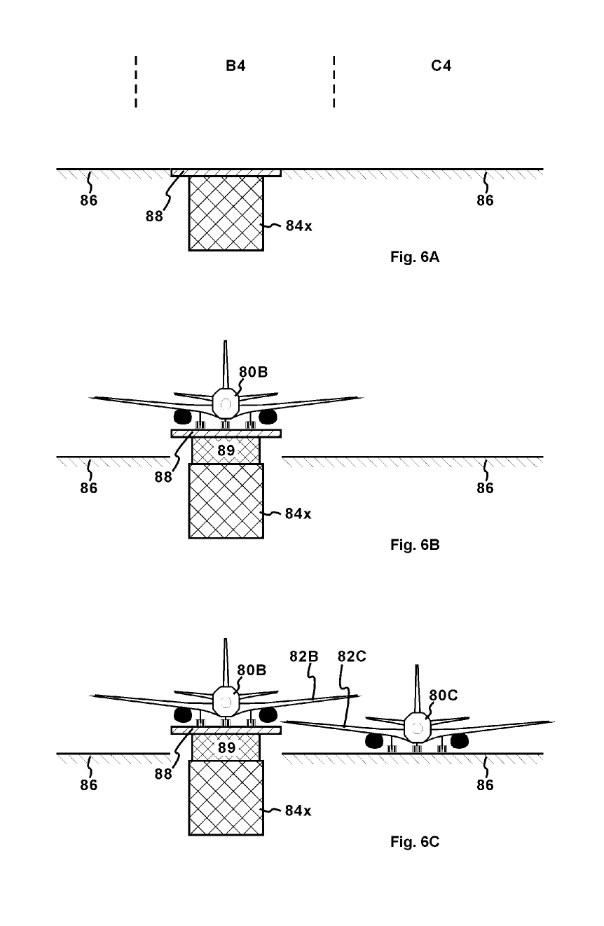

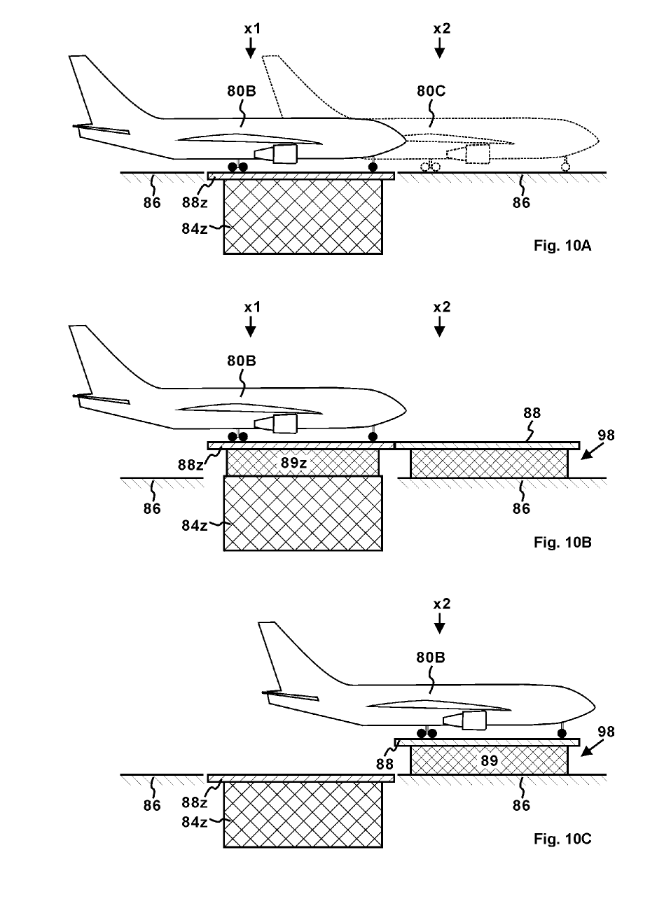

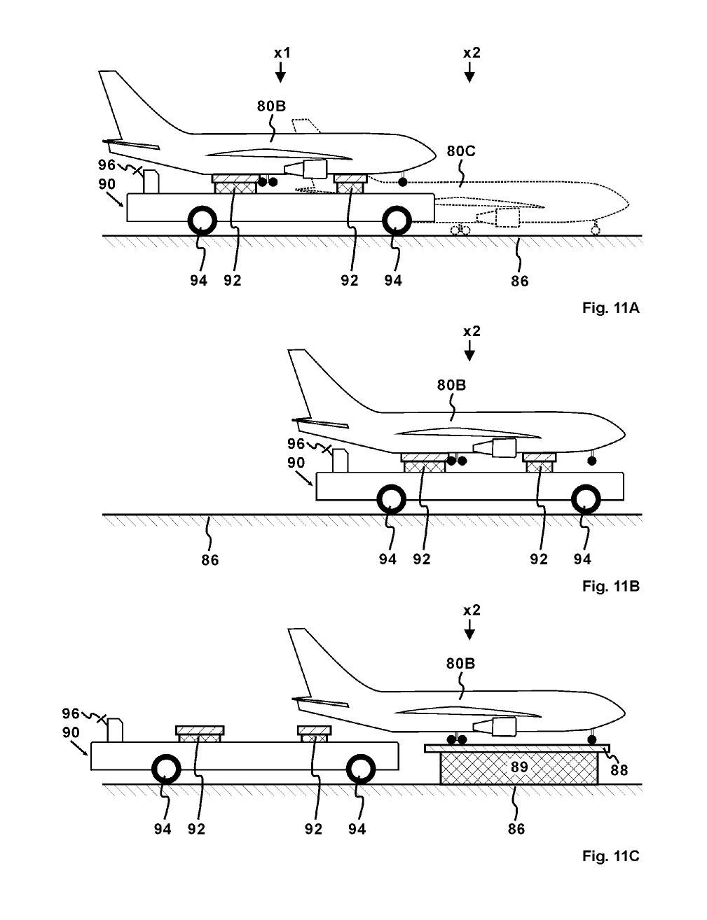

The elevated parking structure 89 is movable. It has two modes including parking mode and non-parking mode. In the parking mode (i.e. when an airplane 80B is parked in the parking space B4), the elevated parking structure 89 supports the airplane 80B on the second parking surface 88. In the non-parking mode (i.e. when no airplane is parked in the parking space B4), the elevated parking structure 89 is cleared off the parking space 84 in such a way that this parking space B4 has a flat surface with surrounding areas and can be used for taxiing or other purposes. Being movable, the sidewalls 85, 87 of the elevated parking structure 89 are plotted with dotted lines (FIGS. 5A-5B) to indicate their movability. Because it does not require a sloping surface connecting two parking surfaces 86, 88, the second type of the 3-D airport requires less apron area. In the following FIGS. 6A-11C, several preferred parking methods for the movable parking structure 89 are disclosed: the movable parking structure 89 of FIGS. 6A-9C can be moved vertically; the movable parking structure 89 of FIGS. 10A-11C can be moved horizontally.

FIGS. 6A-6C illustrate three parking steps used by a first preferred airplane parking method. This preferred 3-D airport comprises a stationary lifting means (e.g. a hydraulic jack) 84x, which can be moved vertically (i.e. retracted) into the first parking surface 86 in the non-parking mode and extended outside the first parking surface 86 in the parking mode. At the first step of FIG. 6A, the parking space B4 is in the non-parking mode. The top surface 88 of the lifting means 84x is level with the first parking surface 86 and can be used for taxiing or other purposes. At the second step of FIG. 6B, an airplane 80B is taxied onto the lifting means 84x. The lifting means 84x extends and lifts the airplane 80B to a designated height. At this time, the extended cylinder of the lifting means 84x becomes the elevated parking structure 89 and the airplane 80B is parked on its top surface 88. At the third step of FIG. 6C, another airplane 80C is taxied into an adjacent parking space C4, whose surface is the first parking surface 86. Because the airplane 80B is parked higher than the airplane 80C, at least a portion of a wing 82B of the airplane 80B can overlap at least another portion of a wing 82C of the airplane 80C. In this preferred embodiment, the airplane (e.g. 80B) that goes in first comes out last.

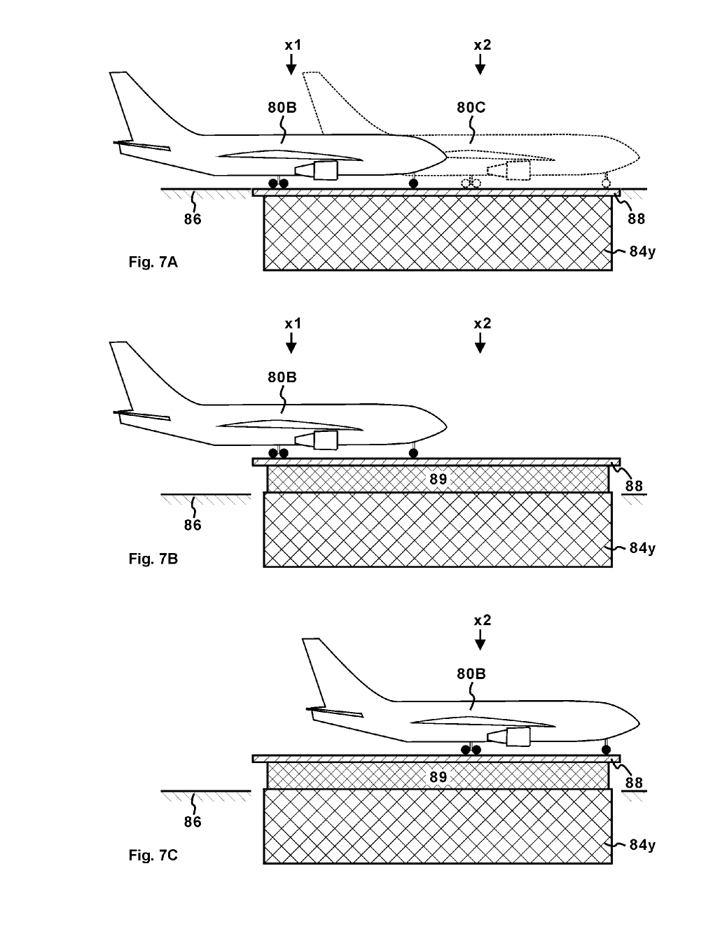

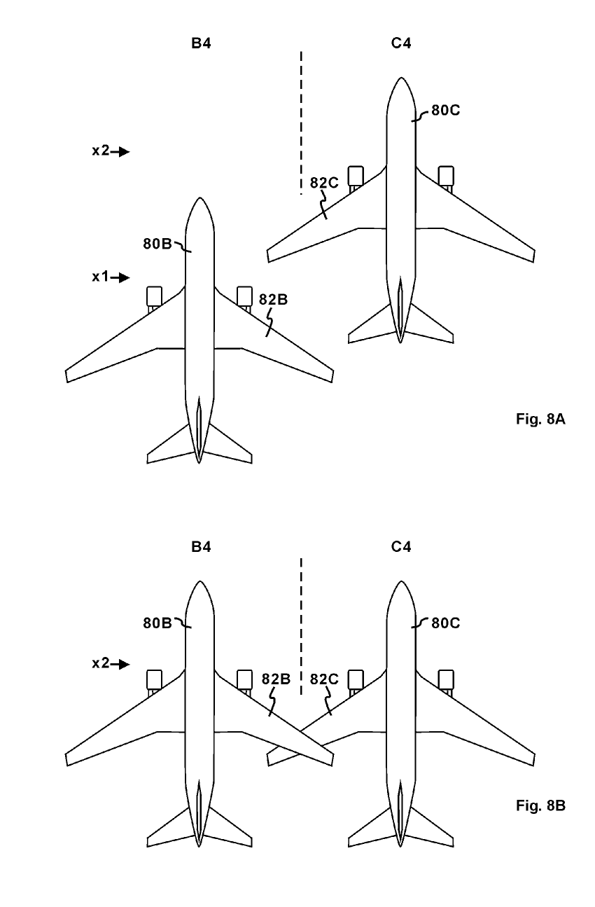

FIGS. 7A-7C and FIGS. 8A-8B illustrate three parking steps used by a second preferred airplane parking method. This preferred 3-D airport comprises another stationary lifting means (e.g. hydraulic jack) 84y. This lifting means 84y is longer than that of FIG. 6A-6C. It extends from the position x2 to position x1 . At the first step of FIG. 7A (side view) and FIG. 8A (top view), an airplane 80C (in dotted lines) is already parked in the parking space C4, while an airplane 80B to be parked at B4. At this time, the lifting means 84y is retracted and its top surface 88 is level with the first parking surface 86. The position x1 of the airplane 80B should be such that its wing 82B would not collide with a wing 82C of the airplane 80C. Because the position x1 is the beginning position of the lifting means 84y, the lifting means 84y is longer than that of FIGS. 6A-6C. At the second step of FIG. 7B (side view, the airplane 80C is not shown in FIGS. 7B-7C), the lifting means 84y extends and lifts the airplane 80B to a designated height. The extended cylinder of the lifting means 84y becomes the elevated parking structure 89. At the third step of FIG. 7C (side view) and FIG. 8B (top view), the airplane 80B taxis to position x2 on the top surface 88 of the elevated parking structure 89. Because the airplane 80B is parked higher than the airplane 80C, at least a portion of a wing 82B of the airplane 80B can overlap at least a portion of a wing 82C of the airplane 80C (FIG. 8B). In this preferred embodiment, the airplane (e.g. 80B) that goes in first comes out first.

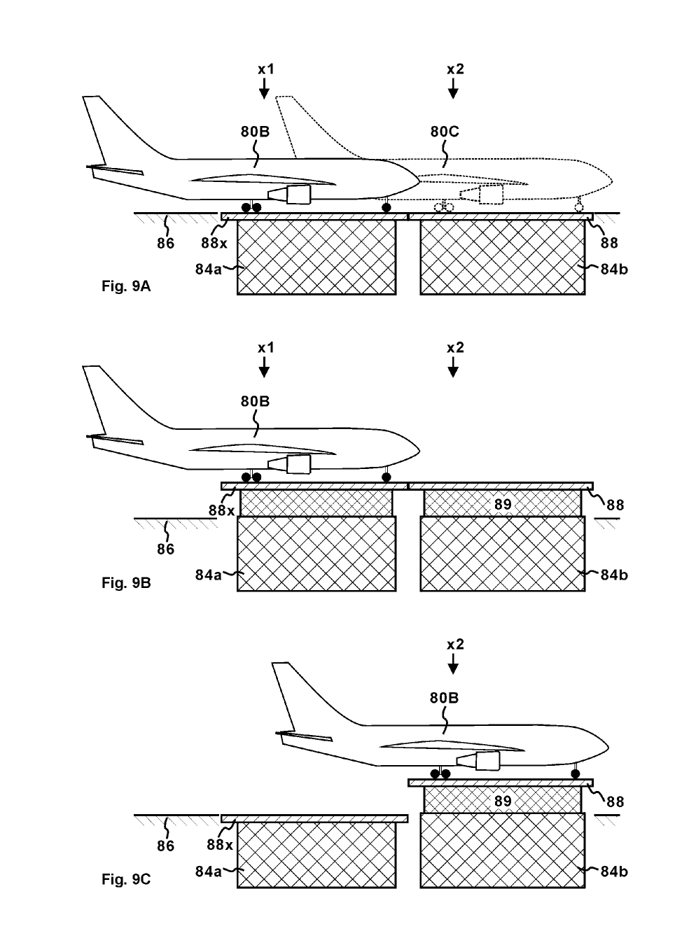

FIGS. 9A-9C illustrate three parking steps used by a third preferred airplane parking method. This preferred 3-D airport comprises a first stationary lifting means (e.g. a first hydraulic jack) 84a and a second stationary lifting means (e.g. a second hydraulic jack) 84b. The first lifting means 84a is located at position xl and the second lifting means 84b is located at position x2. Similar to FIGS. 7A-7C, at the first step of FIG. 9A, the airplane 80B to be parked is positioned at x1 and both lifting means 84a, 84b are retracted and their top surfaces 88x, 88 are level with the first parking surface 86. At the second step of FIG. 9B (the airplane 80C is not shown in FIGS. 9B-9C), the first lifting means 84a extends and lifts the airplane 80B to a designated height. The second lifting means 84b also extends to the same height and its top surface 88 mates with the top surface 88x of the first lifting means 84a. At the third step of FIG. 9C, the airplane 80B taxis to position x2 on the top surface 88 of the second lifting means 84b. Because the airplane 80B is parked on an elevated surface 88, at least a portion of a wing 82B of the airplane 80B can overlap at least a portion of a wing 82C of the airplane 80C. At this moment, the first lifting means 84a can be retracted in such a way that its surface can be used for taxiing or other purposes. In this preferred embodiment, the airplane (e.g. 80B) that goes in first comes out first.

FIGS. 10A-10C illustrate three parking steps used by a fourth preferred airplane parking method. Its movable parking structure 98 can be moved away horizontally from the parking space B4 in the non-parking mode and moved horizontally into the parking space B4 in the parking mode. At the first step of FIG. 10A, the airplane 80B to be parked is positioned at x1 . The preferred 3-D airport further comprises a stationary lifting means (e.g. hydraulic jack) 84z at x1 . At this time, the lifting means 84z is retracted and its top surface 88z is level with the first parking surface 86. At the second step of FIG. 10B, the lifting means 84z extends and lifts the airplane 80B to a designated height. A movable parking structure 98 is moved into position x2 and its top surface 88 mates with the top surface 88z of the lifting means 84z. The movable parking structure 98 may comprise caster wheels or other moving means, which engage the first parking surface 86 when no airplane is parked thereon, and disengage the first parking surface 86 when an airplane is parked thereon. At the third step of FIG. 10C, the airplane 80B taxis onto the top surface 88 of the movable parking structure 98 (i.e. the elevated parking structure 89) and is supported thereon. At this moment, the lifting means 84z is retracted. Because the airplane 80B is parked on an elevated surface 88, at least a portion of a wing 82B of the airplane 80B can overlap at least a portion of a wing 82C of the airplane 80C. The preferred methods disclosed in FIGS. 10A-10C, the airplane (e.g. 80B) that goes in first comes out first.

FIGS. 11A-11C illustrate three parking steps used by a fifth preferred airplane parking method. It comprises a mobile lifting means 90, which comprises at least a lifting means (e.g. hydraulic jack) 92, moving means (e.g. mechanized wheels) 94 and steering means (e.g. steering wheel) 96. At the first step of FIG. 11A, the mobile lifting means 90 addresses the airplane 80B from the rear. Once it is underneath the airplane 80B, the mobile lifting means 90 engages the airplane 80 and lifts the airplane 80B to a designated height with the lifting means 92. At the second step of FIG. 11B, the mobile lifting means 90 moves the airplane 80B into position x2. Because the airplane 80B is now lifted, at least a portion of a wing 82B of the airplane 80B can overlap at least a portion of a wing 82C of the airplane 80C. At the third step of FIG. 11C, a movable parking structure 98 similar to that of FIG. 10B is moved underneath the airplane 80B. After the mobile lifting means 90 disengages the airplane 80B, the airplane 80B is supported by the movable parking structure 98. It should be apparent to those skilled in the art that the step of FIG. 11C is optional and the airplane 80B can be supported by the mobile lifting means 90 in the parking space B4. The preferred methods disclosed in FIGS. 11A-11C, the airplane (e.g. 80B) that goes in first comes out first.

While illustrative embodiments have been shown and described, it would be apparent to those skilled in the art that may more modifications than that have been mentioned above are possible without departing from the inventive concepts set forth therein. For example, the elevated parking structure can be used not only in an airport, but also in an airplane hangar. Besides this, the elevated parking structure can also be used in an aircraft carrier, where the first parking surface is the flight deck thereof. The invention, therefore, is not to be limited except in the spirit of the appended claims.

What is claimed is:

1. A three-dimensional airport, comprising:
a first parking surface and at least a first airplane parked on said first parking surface;
a second parking surface above said first parking surface and at least a second airplane parked on said second parking surface;
wherein at least a portion of a wing of said second airplane overlaps at least another portion of another wing of said first airplane.

2. The airport according to claim 1, further comprising a terminal building comprising first and second boarding bridges, wherein said first parking surface is located around at least a portion of said terminal building and said first airplane is docked at said first boarding bridge; said second parking surface is located around at least another portion of said terminal building and said second airplane is docked at said second boarding bridge.

3. The airport according to claim 1, further comprising an elevated parking structure, wherein said second parking surface is part of said elevated parking structure.

4. The airport according to claim 3, wherein said elevated parking structure is fixed.

5. The airport according to claim 4, wherein said elevated parking structure further comprises a sloping surface connecting said first and second parking surfaces.

6. The airport according to claim 5, further comprising an external means for moving said second airplane along said sloping surface.

7. The airport according to claim 6, wherein said external means is a tug or a tractor.

8. The airport according to claim 6, wherein said external means is a cable system.

9. The airport according to claim 3, wherein said elevated parking structure is movable.

10. The airport according to claim 9, wherein said elevated parking structure can be moved vertically.

11. The airport according to claim 10, further comprising a lifting means, wherein the top surface of said lifting means is at the same level as said first parking surface when retracted, and at the same level as said second parking surface when extended.

12. The airport according to claim 11, wherein said lifting means extends to a position behind said first airplane.

13. The airport according to claim 10, further comprising at least two lifting means.

14. The airport according to claim 9, wherein said elevated parking structure can be moved horizontally.

15. The airport according to claim 14, further comprising a movable parking structure for supporting said second airplane, whereby said movable parking structure can be moved into or away from a designated parking space.

16. The airport according to claim 15, wherein said movable parking structure comprises caster wheels.

17. The airport according to claim 15, wherein said movable parking structure comprises a mobile lifting means.

18. The airport according to claim 1, wherein said airport is a portion of an airplane hangar.

19. The airport according to claim 1, wherein said airport is a portion of an aircraft carrier.

20. The airport according to claim 19, wherein said first parking surface is a flight deck of said aircraft carrier.
